(19) United States
(12) Patent Application Publication
(10) Pub. No.: US 2008/0004855 A1
(43) Pub. Date: Jan. 3, 2008

(54) DESIGN SUPPORT APPARATUS, DESIGN SUPPORT METHOD, AND DESIGN SUPPORT PROGRAM

(76) Inventor: Hidehisa SAKAI, Kawasaki (JP)

Correspondence Address: STAAS & HALSEY LLP, SUITE 700, 1201 NEW YORK AVENUE, N.W., WASHINGTON, DC, 20005, US

(21) Appl. No.: 11/857,136

(22) Filed: Sep. 18, 2007

Related U.S. Application Data
(63) Continuation of application No. PCT/JP2005/004918, filed on Mar. 18, 2005.

(51) Int. Cl. G06F 17/50

(52) U.S. Cl. 703/14

(57) ABSTRACT

A design support apparatus comprises: an experiment plan section 11 that selects a combination of design parameter values by allocating the design parameter values to an orthogonal table; a simulation input creating section 12 that creates an input into the simulation by allocating outside factors such as an error factor and a signal factor as inside factors to an orthogonal table to thereby reduce the number of combinations of the design parameter values: a simulation instructing section 21 that issues an instruction to execute the simulation by using the input into the simulation; and an analyzing section 30 that calculates a set of design parameter values and a characteristic value based on results of the simulation and performs analysis.

### CROSS REFERENCE TO RELATED APPLICATION

This application is a continuation application, filed under 35 USC 111(a), of International Application PCT/JP2005/004918, filed Mar. 18, 2005, which is herein incorporated by reference in its entirety.

### TECHNICAL FIELD

The present invention relates to a design support apparatus, a design support method, and a design support program that use quality engineering and a simulation approach to evaluate a relationship between design parameters and characteristics of an object to be designed in an effective manner.

### BACKGROUND ART

The density and integration degree is increasing year by year in the field of an electronic apparatus such as a computer and mobile phone. Accordingly, it is necessary not only to guarantee sufficient quality of the apparatus in a design stage of such an apparatus, but also verify whether intended functions thereof can fully be achieved at the same time. As a method for evaluating quality or functions of an apparatus to be produced before its trial production, there is known a CAE (Computer Aided Engineering) system which is based on a simulation technique such as a finite element method. Today, an evaluation approach based on the CAE system is essential for design and development of a new product.

An evaluation approach based on only a simulation technique can only verify whether a given design plan satisfies its required specification. Thus, it is impossible to grasp the influence of a given design parameter on a characteristic value, the influence of a variation in a design parameter on a characteristic value, or the like. In order to analyze the above influence, a combination of quality engineering analysis and simulation technique is effective.

As a prior art relating to the present invention, Patent Document 1 described below is known, for example. In a facility reliability design support apparatus disclosed in Patent Document 1, design parameters of a facility and its components are allocated to an orthogonal table based on Taguchi Method, analysis on a design analysis model or inverse analysis model is performed based on the orthogonal table, a response surface is calculated based on a result of the analysis, and design optimization is made by using the calculated response surface. Patent Document 1: Jpn. Pat. Appln. Laid-Open Publication No. 2001-125933

### DISCLOSURE OF INVENTION

### Problems to be Solved by the Invention

However, a conventional quality engineering analysis involves a large number of simulations and, therefore, a large number of man-hours are required. In addition, it may take several days to obtain a result in some cases, making it difficult to achieve a quick evaluation. Further, a designer must master the analysis procedure of quality engineering, experimental design, or the like and, in the case where he or she has not mastered it, the help of a specialist, etc. is required. Further, the conventional quality engineering analysis can analyze the influence of a given design parameter on a characteristic value but has difficulty in obtaining a variation in the characteristic value in the case where a design parameter is varied to a value different from its original value. Further, although all characteristic values obtained by simulations are treated as one collective characteristic in the conventional quality engineering analysis, this collective characteristic includes a range that cannot be designed, degrading the accuracy in a designable range.

The present invention has been made to solve the abovementioned problems, and an object thereof is to provide a design support apparatus, a design support method, and a design support program for easily performing highly accurate analysis with respect to a relationship between design parameters and characteristics of an object to be designed.

### Means for Solving the Problems

To solve the above problems, according to a first aspect of the present invention, there is provided a design support apparatus that uses a simulation for obtaining a characteristic value of an object to be designed from a combination of design parameter values such as a control factor, error factor, and signal factor to analyze a relationship between the design parameter values and characteristic value, comprising: an experiment plan section that selects a combination of design parameter values by allocating the design parameter values to an orthogonal table; a simulation input creating section that creates an input into the simulation by allocating outside factors such as an error factor and a signal factor as inside factors to an orthogonal table to thereby reduce the number of combinations of the design parameter values; a simulation instructing section that issues an instruction to execute the simulation by using the input into the simulation; and an analyzing section that calculates a set of design parameter values and a characteristic value based on results of the simulation and performs analysis.

The design support apparatus according to the present invention further comprises a response surface calculating section that uses the design parameter values and characteristic value obtained as a result of the simulation to calculate a response surface representing a relationship between the design parameter values and characteristic value, wherein the analyzing section uses the response surface to calculate a given set of design parameter values and characteristic value to perform analysis.

The design support apparatus according to the present invention further comprises a clustering section that selects a set of design parameter values and characteristic value that satisfies a predetermined criterion and classifies the selected set thereof into clusters based on a distance between points represented by the selected sets thereof, wherein the analyzing section uses the clustered sets of design parameter values and characteristic value to perform analysis.

Further, according to a second aspect of the present invention, there is provided a design support apparatus that creates, as a simulation input file, a setting required for a simulation for obtaining a characteristic value of an object to be designed from a combination of design parameter values such as a control factor, error factor, and signal factor, comprising: an experiment plan section that selects a combination of design parameter values by allocating the design parameter values to an orthogonal table; and a simulation input creating section that previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

In the design support apparatus according to the present invention, the simulation input creation section allocates outside factors such as an error factor and a signal factor as inside factors to an orthogonal table to thereby reduce the number of combinations of the design parameter values, previously prepares a correspondence between design parameter names and identifiers, previously prepares a simulation input template file which is a file describing the design parameter values using corresponding identifiers for the setting of the simulation, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

Further, according to a third aspect of the present invention, there is provided a design support method that uses a simulation for obtaining a characteristic value of an object to be designed from a combination of design parameter values such as a control factor, error factor, and signal factor to analyze a relationship between the design parameter values and characteristic value, comprising: an experiment plan step that selects a combination of design parameter values by allocating the design parameter values to an orthogonal table; a simulation input creating step that creates an input into the simulation by allocating outside factors such as an error factor and a signal factor as inside factors to an orthogonal table to thereby reduce the number of combinations of the design parameter values; a simulation instructing step that issues an instruction to execute the simulation by using the input into the simulation; and an analyzing step that calculates a set of design parameter values and a characteristic value based on results of the simulation and performs analysis.

The design support method according to the present invention further comprises, between the simulation instructing step and the analyzing step, a response surface calculating step that uses the design parameter values and characteristic value obtained as a result of the simulation to calculate a response surface representing a relationship between the design parameter values and characteristic value, wherein the analyzing step uses the response surface to calculate a given set of parameter values and characteristic value to perform analysis.

The design support method according to the present invention further comprises, between the simulation instructing step and the analyzing step, a clustering step that selects a set of design parameter values and characteristic value that satisfies a predetermined criterion and classifies the selected set thereof into clusters based on a distance between points represented by the selected sets thereof, wherein the analyzing step uses the clustered sets of design parameter values and characteristic value to perform analysis.

Further, according to a fourth aspect of the present invention, there is provided a design support method that creates, as a simulation input file, a setting required for a simulation for obtaining a characteristic value of an object to be designed from a combination of design parameter values such as a control factor, error factor, and signal factor, comprising: an experiment plan step that selects a combination of design parameter values by allocating the design parameter values to an orthogonal table; and a simulation input creating step that previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

In the design support method according to the present invention, the simulation input creation step allocates outside factors such as an error factor and a signal factor as inside factors to an orthogonal table to thereby reduce the number of combinations of the design parameter values, previously prepares a correspondence between design parameter names and identifiers, previously prepares a simulation input template file which is a file describing the design parameter values using corresponding identifiers for the setting of the simulation, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

According to a fifth aspect of the present invention, there is provided a design support program allowing a computer to execute a design support method that uses a simulation for obtaining a characteristic value of an object to be designed from a combination of design parameter values such as a control factor, error factor, and signal factor to analyze a relationship between the design parameter values and characteristic value, the program allowing the computer to execute: an experiment plan step that selects a combination of design parameter values by allocating the design parameter values to an orthogonal table; a simulation input creating step that creates an input into the simulation by allocating outside factors such as an error factor and a signal factor as inside factors to an orthogonal table to thereby reduce the number of combinations of the design parameter values; a simulation instructing step that issues an instruction to execute the simulation by using the input into the simulation; and an analyzing step that calculates a set of design parameter values and a characteristic value based on results of the simulation and performs analysis.

### BRIEF DESCRIPTION OF DRAWINGS

FIG. 1 is a block diagram showing an example of a configuration of a design support apparatus according to a first embodiment;

FIG. 2 is a flowchart showing an example of operation of the design support apparatus according to the first embodiment;

FIG. 3 is an orthogonal table showing an example of allocation of design parameters in a first case according to the present invention;

FIG. 4 is an orthogonal table showing an example of allocation of design parameters in a second case according to the present invention;

FIG. 5 is an orthogonal table showing an example of allocation of design parameters in a third case according to the present invention;

FIG. 6 is an orthogonal table showing an example of allocation of design parameters in a fourth case according to the present invention;

FIG. 7 is a view showing an example of an analysis pattern setting GUI according to the present invention used in creation of an orthogonal table;

FIG. 8 is a view showing an example of a control factor setting GUI according to the present invention used in creation of an orthogonal table;

FIG. 9 is a view showing an example of a control factor combination setting GUI according to the present invention used in creation of an orthogonal table;

FIG. 10 is a view showing an example of an error factor setting GUI according to the present invention used in creation of an orthogonal table;

FIG. 11 is a table showing an example of a correspondence between variable names and variable numbers according to the present invention;

FIG. 12 is a table showing an example of a simulation input template file according to the present invention;

FIG. 13 is a table showing an example of a simulation input file according to the present invention;

FIG. 14 is a view showing an example of a GUI for browsing evaluation characteristic values according to the present invention;

FIG. 15 is a flowchart showing an example of a first analysis method according to the first embodiment;

FIG. 16 is a view showing an example of a display of an analysis result obtained by a quality engineering analyzing section according to the present invention;

FIG. 17 is a flowchart showing an example of a second analysis method according to the first embodiment;

FIG. 18 is a view showing an example of a setting GUI for display of an analysis result obtained by a response surface calculating section according to the present invention;

FIG. 19 is a flowchart showing an example of a third analysis method according to the first embodiment;

FIG. 20 is a flowchart showing an example of a fourth analysis method according to the first embodiment;

FIG. 21 is a view showing an example of operation of a clustering section according to the present invention;

FIG. 22 is a flowchart showing an example of a fifth analysis method according to the first embodiment;

FIG. 23 is a flowchart showing an example of a sixth analysis method according to the first embodiment;

FIG. 24 is a block diagram showing an example of a configuration of a design support apparatus according to a second embodiment;

FIG. 25 is a flowchart showing an example of operation of the design support apparatus according to the second embodiment;

FIG. 26 is an orthogonal table showing an example of allocation of error factors in normal quality engineering;

FIG. 27 is an orthogonal table showing an example of allocation of error factors made by a simulation input creating section according to the second embodiment;

FIG. 28 is a flowchart showing an example of a first analysis method according to the second embodiment;

FIG. 29 is a flowchart showing an example of a second analysis method according to the second embodiment;

FIG. 30 is a flowchart showing an example of a third analysis method according to the second embodiment;

FIG. 31 is a flowchart showing an example of a fourth analysis method according to the second embodiment; and

FIG. 32 is a flowchart showing an example of a fifth analysis method according to the second embodiment.

### BEST MODE FOR CARRYING OUT THE INVENTION

Embodiments of the present invention will be described with reference to the accompanying drawings.

### First Embodiment

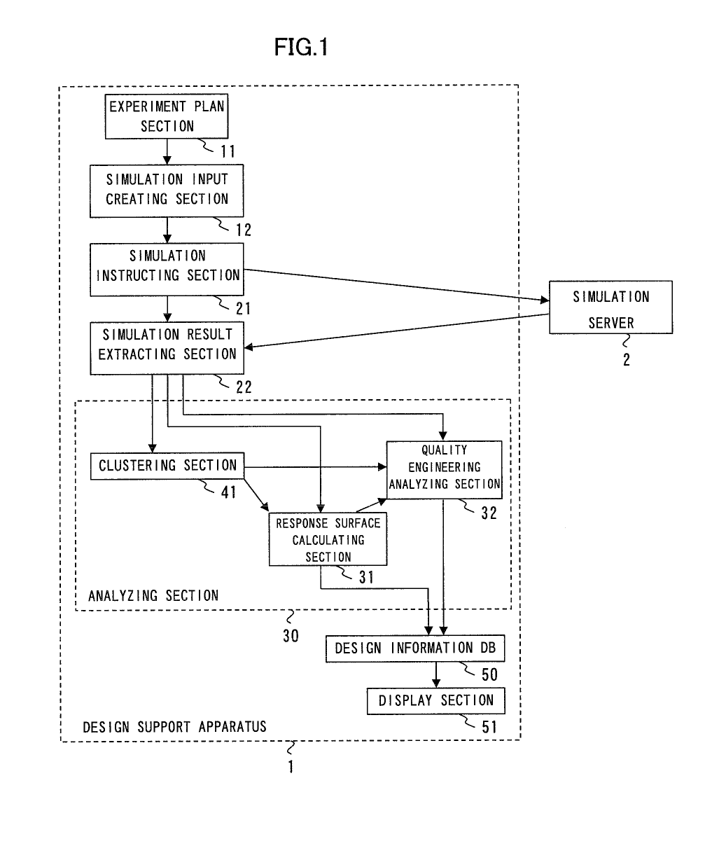

First, a configuration of a design support apparatus according to the present embodiment will be described. FIG. 1 is a block diagram showing an example of a configuration of a design support apparatus according to a first embodiment. The design support apparatus 1 shown in FIG. 1 includes an experiment plan section 11, a simulation input creating section 12, a simulation instructing section 21, a simulation result extracting section 22, an analyzing section 30, a design information DB (database) 50, and a display section 51. The analyzing section 30 includes a response surface calculating section 31, a quality engineering analyzing section 32, and a clustering section 41. A simulation server 2 shown in FIG. 1 performs a simulation for an object to be designed according to a simulation input file received from the simulation instructing section 21 and transmits a simulation result to the simulation result extracting section 22. In this simulation, design parameter values included in the simulation input file are used to perform evaluation to thereby calculate a characteristic value of the object to be designed, and the calculated characteristic value is included in the simulation result as an evaluation characteristic value.

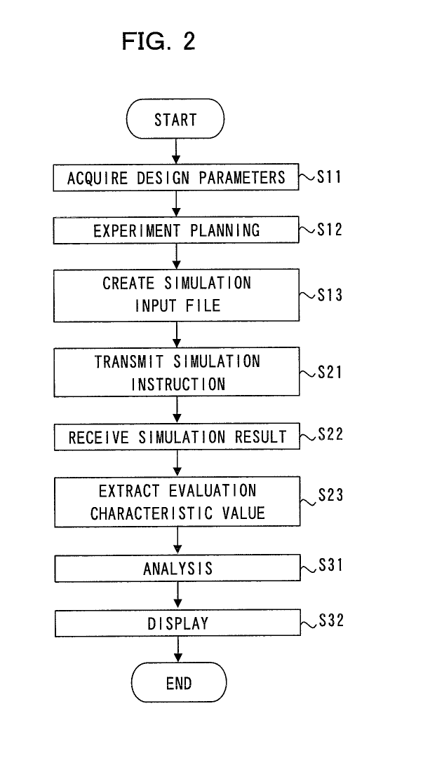

Next, operation of the design support apparatus according to the first embodiment will be described. FIG. 2 is a flowchart showing an example of operation of the design support apparatus according to the first embodiment. The experiment plan section 11 acquires variable names corresponding to control, error, and signal factors which serve as design parameters, the number of levels of each variable, and level values thereof through GUI (Graphical User Interface) input or file input by a user (S11).

Then, the experiment plan section 11 creates an orthogonal table according to the design parameter type, number of each variable, number of levels of each variable to select an appropriate combination of design parameter values and transmits the selected combination to the simulation input creating section 12 (S12). At this time, the experiment plan section 11 automatically performs selection of an appropriate orthogonal table and allocation of the design parameter values to the selected orthogonal table to thereby select an appropriate combination of the design parameter values. A method for creating the orthogonal table according to the design parameters can be applied to the following four cases.

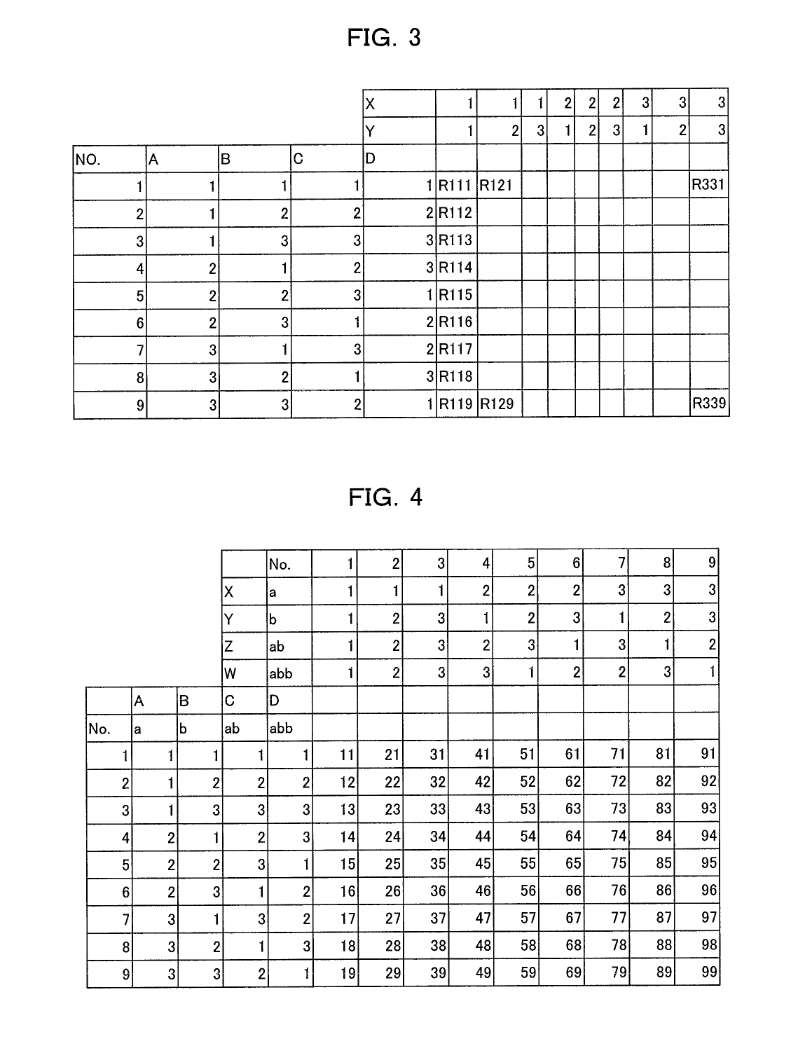

A first case is a case where: control factors are allocated to an appropriate orthogonal table; all combinations of error factors are made; signal factors are not included. FIG. 3 is an orthogonal table showing an example of allocation of design parameters in a first case according to the present invention. In this example, A, B, C, and D are control factors, and X and Y are error factors.

A second case is a case where: control factors and error factors are allocated to an appropriate orthogonal table and a direct product experiment is carried out; signal factors are not included. FIG. 4 is an orthogonal table showing an example of allocation of design parameters in a second case according to the present invention. In this example, A, B, C, and D are control factors, and X, Y, Z and W are error factors.

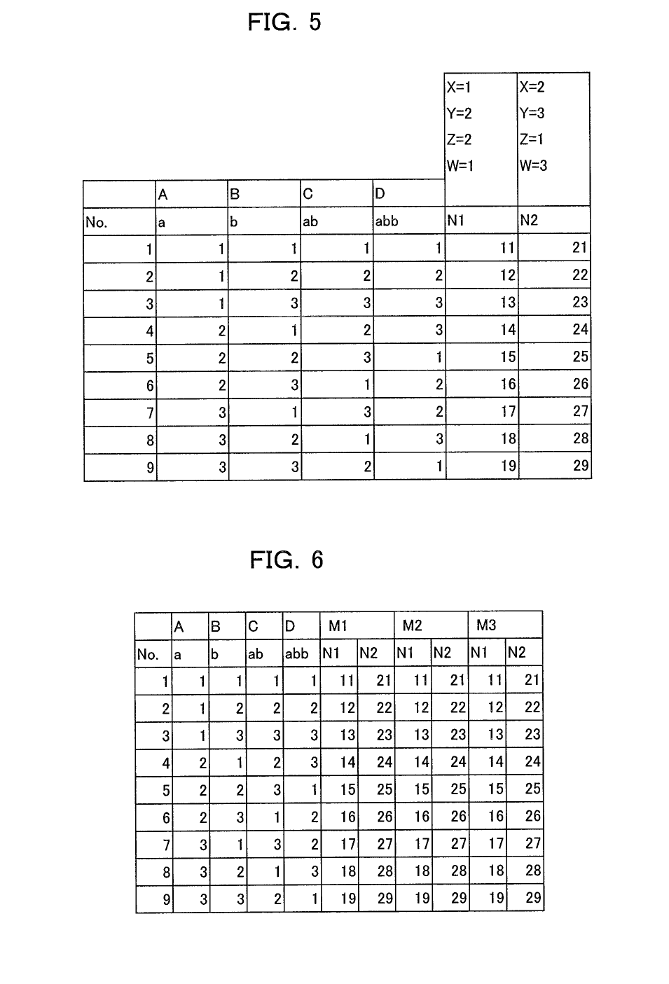

A third case is a case where: control factors are allocated to an appropriate orthogonal table; error factors are compounded to consolidate the number of conditions down to 2 to 3; signal factors are not included. FIG. 5 is an orthogonal table showing an example of allocation of design parameters in a third case according to the present invention. In this example, A, B, C, and D are control factors, X, Y, Z and W are error factors, and N1 and N2 are conditions.

A fourth case is a case where dynamic characteristics are taken into consideration, in which: control factors are allocated to an appropriate orthogonal table; signal factors are included. The fourth case can simulate all combinations realized in the error factor allocation method described in the above first to third cases. FIG. 6 is an orthogonal table showing an example of allocation of design parameters in a fourth case according to the present invention. In this example, A, B, C, and D are control factors, M1, M2, and M3 are signal factors, and N1 and N2 are conditions.

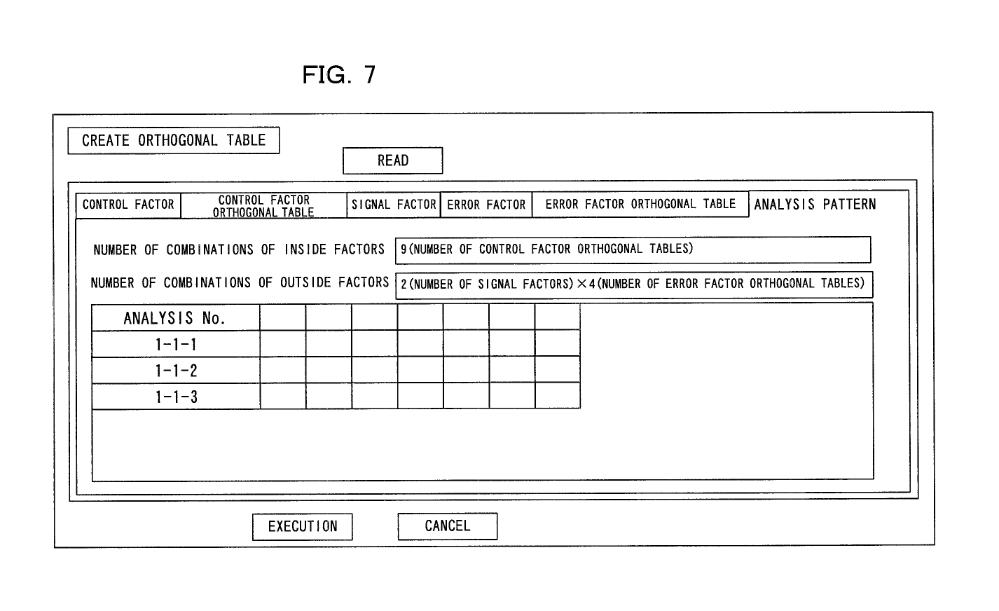

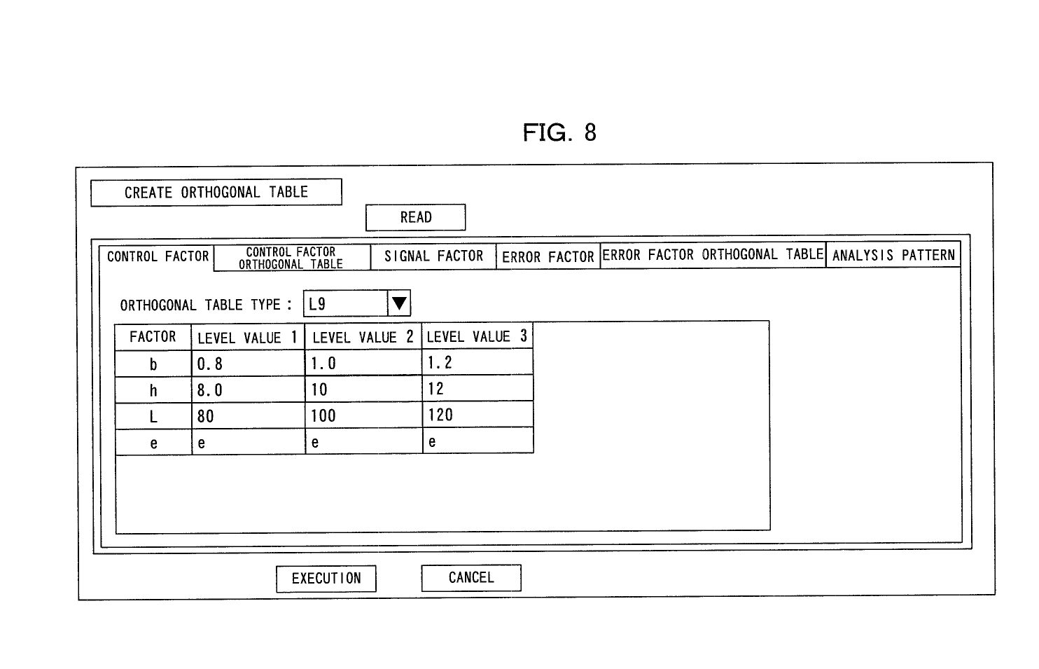

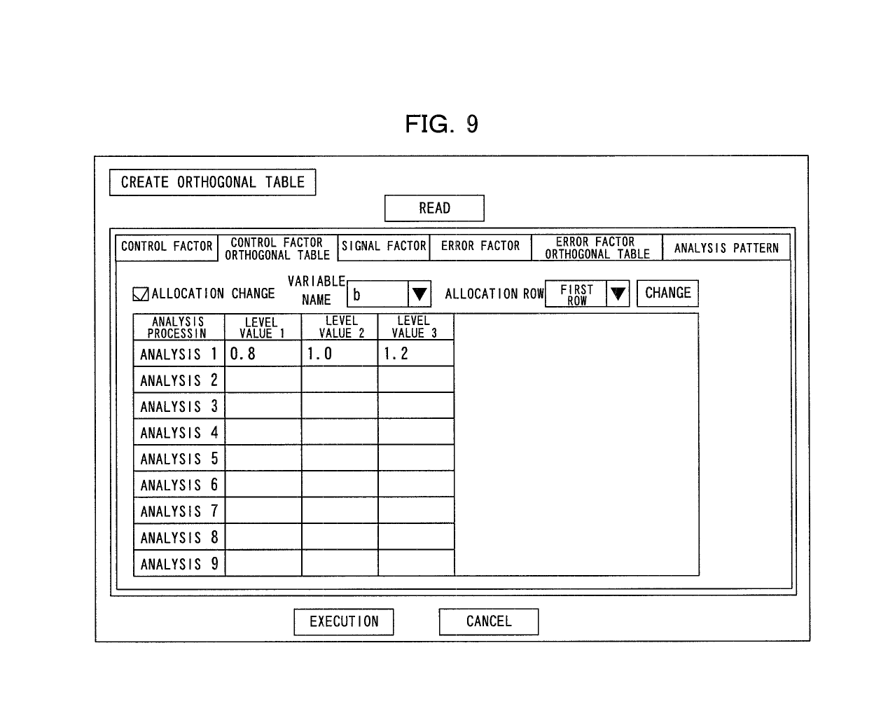

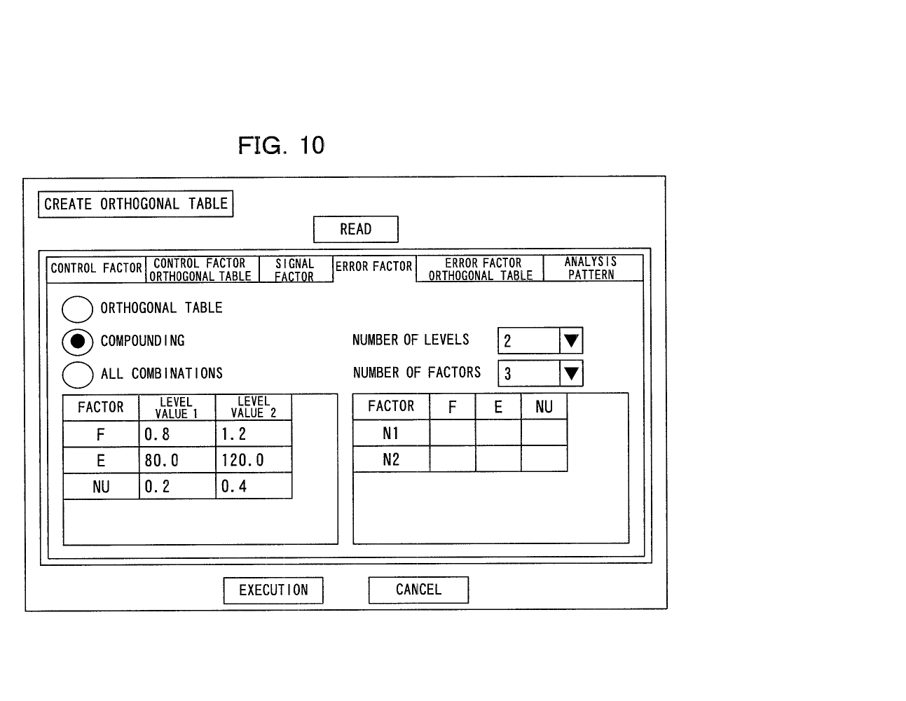

Here are some examples of GUIs used for creating an orthogonal table. FIG. 7 is a view showing an example of an analysis pattern setting GUI according to the present invention used in creation of an orthogonal table. Here, a user sets the number of combinations of inside and outside factors. FIG. 8 is a view showing an example of a control factor setting GUI according to the present invention used in creation of an orthogonal table. Here, the user sets the type of the orthogonal table, name of each control factor variable, number of levels of each control factor variable. FIG. 9 is a view showing an example of a control factor combination setting GUI according to the present invention used in creation of an orthogonal table. Here, the user sets combinations of the control factors based on the orthogonal table. FIG. 10 is a view showing an example of an error factor setting GUI according to the present invention used in creation of an orthogonal table. Here, the user sets the name and number of levels of each error factor variable and makes setting of the compounding of the error factors.

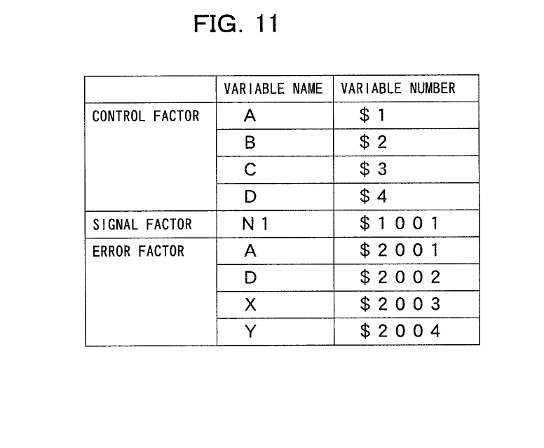

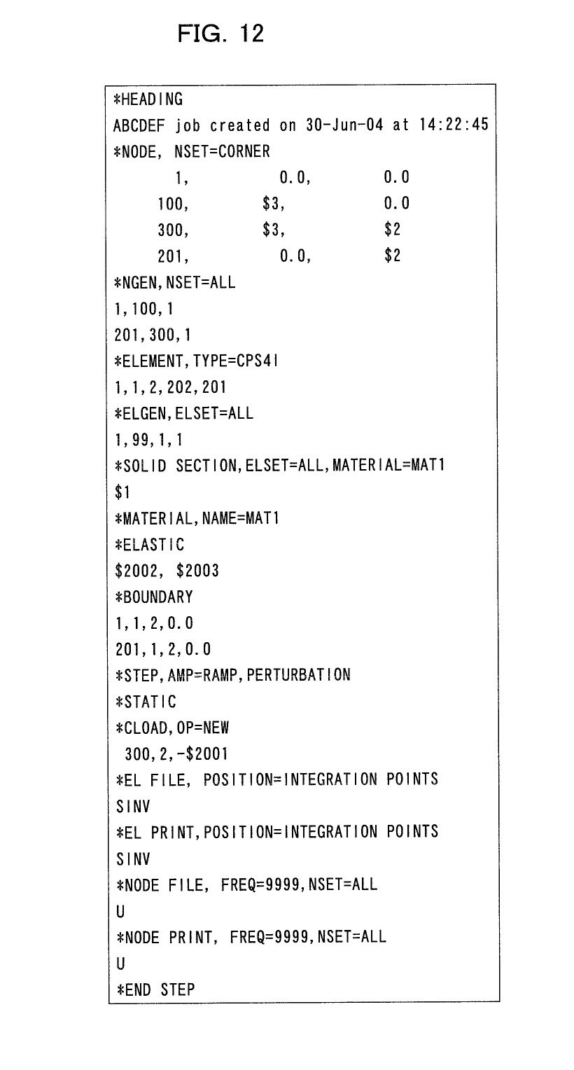

Then, the simulation input creating section 12 uses the design parameter combinations acquired by the experiment plan section 11 and a previously prepared simulation input template file to create a simulation input file for each design parameter combination and transmits the created simulation input file to the simulation instructing section 21 (S13). The simulation input file is a file describing a setting to be input to a simulation. The simulation input template file is a file describing a basic setting, based on which the simulation input file is generated. In the simulation input template file, each variable is represented by a variable number marked with “$”. FIG. 11 is a table showing an example of a correspondence between variable names and variable numbers according to the present invention. The variable names of the control factors are sequentially associated with variable numbers starting from $1 in the order of appearance, variable names of the error factors are sequentially associated with variable numbers starting from $1001 in the order of appearance, and variable names of the signal factors are sequentially associated with variable numbers starting from $2001 in the order of appearance. FIG. 12 is a table showing an example of the simulation input template file according to the present invention. The simulation input template file includes variable numbers marked with “$”. Although variable numbers marked with “$” are used here, another identifier may be used.

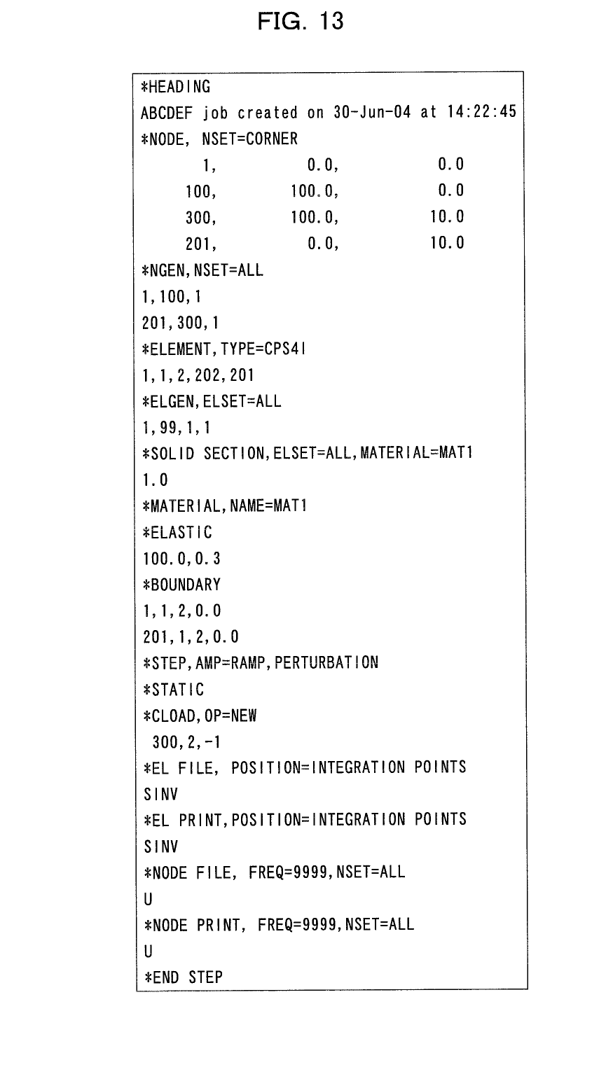

The variable numbers in the simulation input template file are replaced with the variable values for each design parameter combination obtained by the experiment plan section 11 according to the correspondence between the variable names and numbers and, thereby, the simulation input file is obtained in the simulation input creating section 12. In the case where the error factor name and control factor name do not coincide with each other, the above replacement is made without problem. However, in the case where the error factor name and control factor name coincide with each other, the above replacement is made after the error factor name is recognized as the variable name of error with respect to the control factor. For example, error factor A has the same variable name as control factor A in the table shown in FIG. 11, so that error factor A is treated as error factor AA. Further, “$1” in the simulation input template file is replaced with a value of control factor A in the simulation input file, and “$2001” in the simulation input template file is replaced with a value obtained by A +AA (in which error factor is included in the control factor). FIG. 13 is a table showing an example of the simulation input file according to the present invention. As shown in FIG. 13, the variable numbers in the simulation input template file of FIG. 12 are replaced with the variable numbers. Simply by preparing one simulation template file using the simulation input creating section 12, it is possible to create a large number of simulation input files as well as to perform adequate processing even when the error factor name and control factor name coincide with each other.

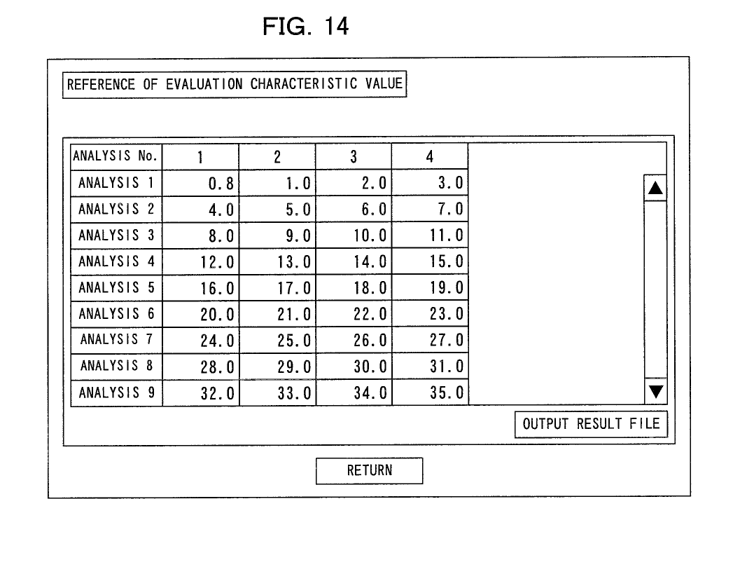

Then, the simulation instructing section 21 transmits the simulation input file to the simulation server 2 to thereby instruct the simulation server 2 to execute a simulation (S21). Upon receiving a simulation result from the simulation server 2 (S22), the simulation result extracting section 22 extracts an evaluation characteristic value required for analysis from the simulation result, pairs the design parameter values and evaluation characteristic value on a per simulation basis, and transmits the set thereof to the analyzing section 30 (S23). The extracted evaluation characteristic value can be referred to. FIG. 14 is a view showing an example of a GUI for browsing evaluation characteristic values according to the present invention. The GUI of FIG. 14 displays evaluation characteristic values on a per simulation basis.

Then, the analyzing section 30 performs analysis according to an analysis method specified by a user and stores an analysis result in the design information database 50 (S31). Subsequently, the display section 51 displays the analysis result (S32), and the flow is ended.

Next, details of operation performed in the analyzing section 30 will be described. The analyzing section 30 performs analysis using an analysis method selected by a user. Here, six analysis methods will be described.

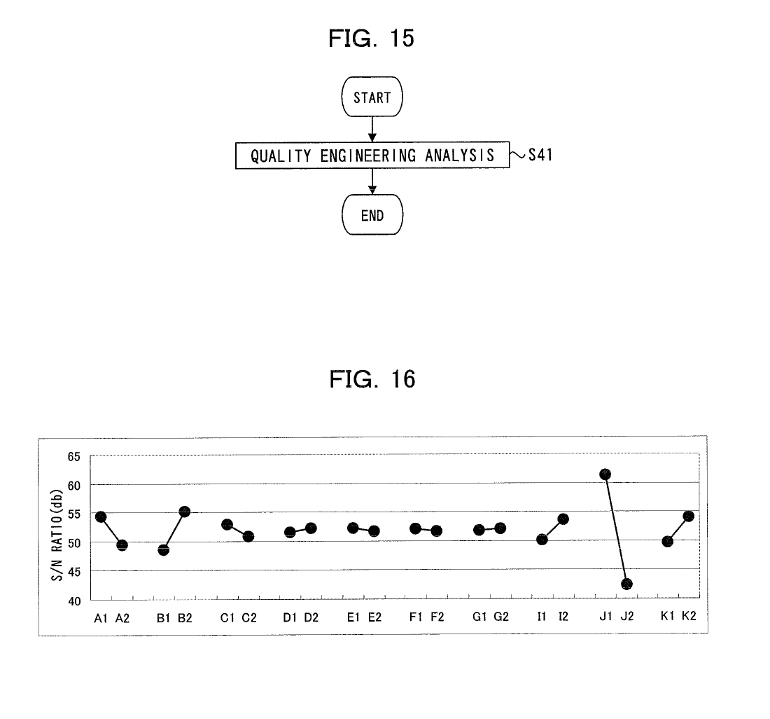

FIG. 15 is a flowchart showing an example of a first analysis method according to the first embodiment. In the first analysis method, the quality engineering analyzing section 32 calculates the degree of influence that the control factor exerts on the evaluation characteristic value based on sets of the input design parameter values and evaluation characteristic value, stores the calculated influence degree in the design information database as an analysis result (S41), and ends this flow. The influence is, e.g., S/N ratio. The influence degree which is an analysis result can be displayed by the display section 51. FIG. 16 is a view showing an example of a display showing the analysis result obtained by the quality engineering analyzing section according to the present invention. The example of FIG. 16 is a case where ten two-level control factors have been analyzed and shows a variation in S/N ratio [dB] with respect to a variation in the level value of each control factor. For example, when the level value of control factor A is changed from A1 to A2, the S/N ratio varies by about −5 dB.

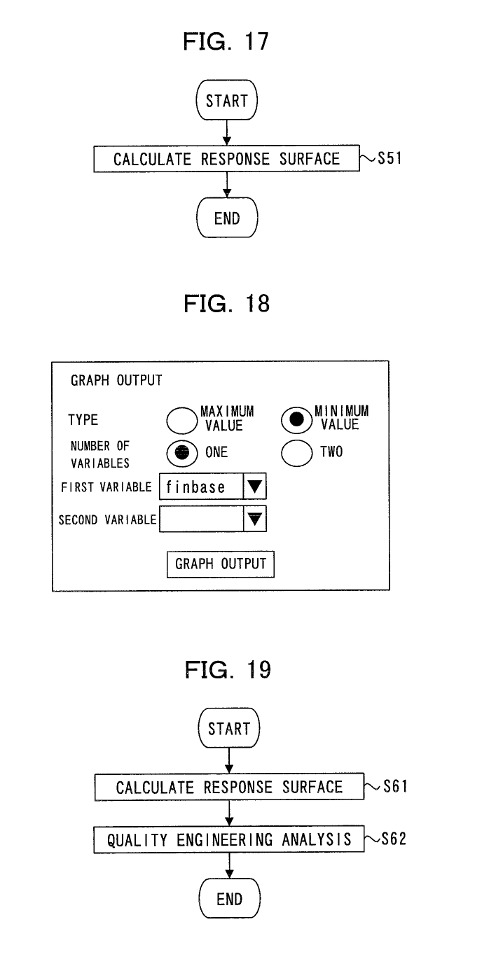

FIG. 17 is a flowchart showing an example of a second analysis method according to the first embodiment. In the second analysis method, the response surface calculating section 31 uses a least-square method to calculate, from the sets of the input design parameter values and evaluation characteristic value, a response surface which is an approximate expression representing a relationship between the design parameter values and evaluation characteristic value, stores the calculated response surface in the design information database as an analysis result (S51), and ends this flow. FIG. 18 is a view showing an example of a setting for display of an analysis result obtained by the response surface calculating section according to the present invention. When a “graph output” button is clicked after completion of display setting, a response surface graph which is an analysis result is displayed by the display section 51.

FIG. 19 is a flowchart showing an example of a third analysis method according to the first embodiment. In the third analysis method, the response surface calculating section 31 calculates a response surface in a manner similar to step S51 and outputs the calculated response surface to the quality engineering analyzing section 32 (S61). Then, the quality engineering analyzing section 32 uses the response surface obtained from the response surface calculating section 31 to calculate the degree of influence that a given value of the control factor exerts on the characteristic value, stores the calculated influence degree in the design information database as an analysis result (S62), and ends this flow.

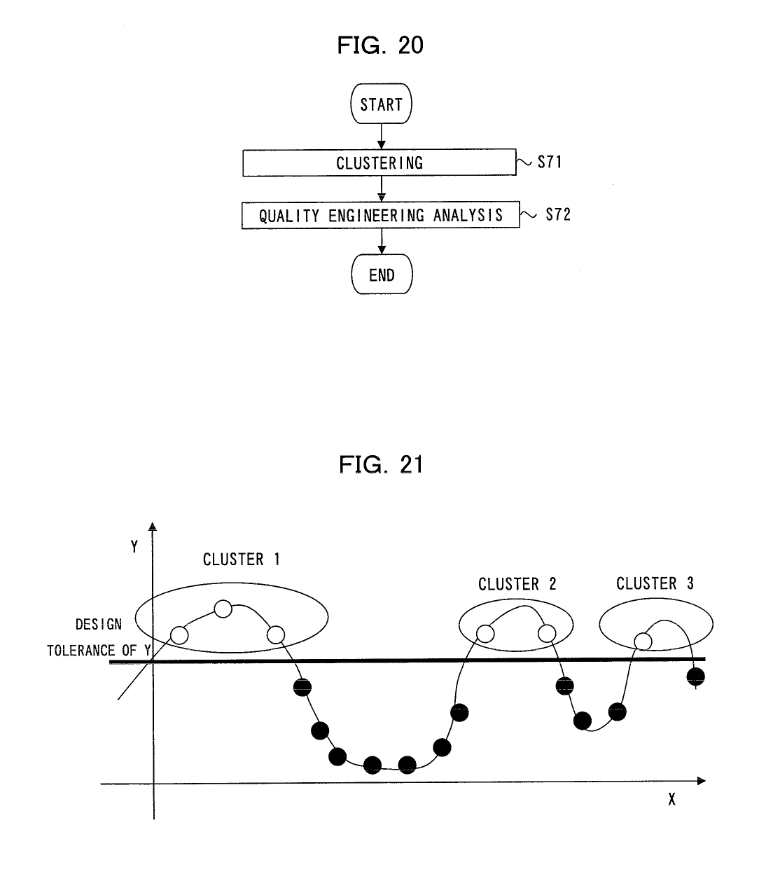

FIG. 20 is a flowchart showing an example of a fourth analysis method according to the first embodiment. In the fourth analysis method, the clustering section 41 selects, from the input sets of the design parameters and evaluation characteristic value, any set each including an evaluation characteristic value not less than the previously set design tolerance. An evaluation characteristic value having a value not less than the design tolerance is determined to be one that can be designed. The clustering section 41 then performs clustering to classify the selected set into clusters and outputs, on a per cluster basis, the sets of the design parameter values and evaluation characteristic value to the quality engineering analyzing section 32 (S71). Here, an Euclidean distance or Mahalanobis distance which is a distance between points represented by the set of the design parameter values and evaluation characteristic value is calculated, adjacent points in terms of distance are grouped as a cluster and clustering is performed. Then, the quality engineering analyzing section 32 calculates the degree of influence on a per cluster basis in a manner similar to step S41, stores the calculated influence degree in the design information database as an analysis result on a per cluster basis (S72), and ends this flow.

FIG. 21 is a view showing an example of operation of the clustering section according to the present invention. The horizontal axis denotes one 17-level control factor X, and vertical axis denotes evaluation characteristic value Y. The bold line denotes the design tolerance of Y. One in which the value of Y exceeds the design tolerance is a solution that can be designed. In this example, points each composed of set of X and Y that can be designed is classified into three clusters. The degree of influence that control factor X of a solution exerts on evaluation characteristic value Y differs from one cluster to another. For example, in cluster 1, Y varies a little even if X varies significantly. On the other hand, in clusters 2 and 3, the variation rate of Y relative to the variation of X is great. By classifying the selected sets into clusters and analyzing individual clusters as described above, highly accurate analysis can be achieved.

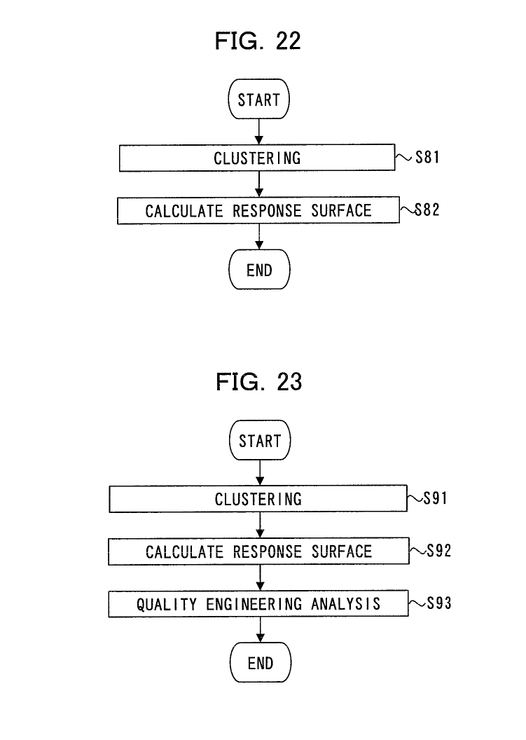

FIG. 22 is a flowchart showing an example of a fifth analysis method according to the first embodiment. The clustering section 41 performs clustering in a manner similar to step S71 and outputs the sets of the design parameter values and evaluation characteristic value on a per cluster basis to the response surface calculating section 31 (S81). Then, the response surface calculating section 31 calculates, on a per cluster basis, a response surface in a manner similar to step S51, stores the calculated response surface in the design information database as an analysis result on a per cluster basis (S82), and ends this flow.

FIG. 23 is a flowchart showing an example of a sixth analysis method according to the first embodiment. The clustering section 41 performs clustering in a manner similar to step S71 and outputs the sets of the design parameter values and evaluation characteristic value on a per cluster basis to the response surface calculating section 31 (S91). Then, the response surface calculating section 31 calculates, on a cluster basis, a response surface in a manner similar to step S51 and outputs the calculated response surface to the quality engineering analyzing section 32 (S92). Then, the quality engineering analyzing section 32 uses the response surface obtained from the response surface calculating section 31 to calculate, on a per cluster basis, the degree of the influence that a given value of the control factor, which is obtained based on the weighted center of the cluster, exerts on the characteristic value, stores the calculated influence degree in the design information database as an analysis result on a per cluster basis (S93), and ends this flow.

There is no need to provide all the components in the embodiment described above, and a configuration including only a part of the components allows the object of the present invention to be achieved. Similarly, there is no need to provide all the analysis methods.

### Second Embodiment

When the number of the exterior factors such as error factors or signal factors, or number of levels of each exterior factor is large in the design support apparatus according to the first embodiment, the number of simulations becomes enormous, involving much longer time for execution of all simulations. In the second embodiment, a design support apparatus that reduces the number of simulations will be described.

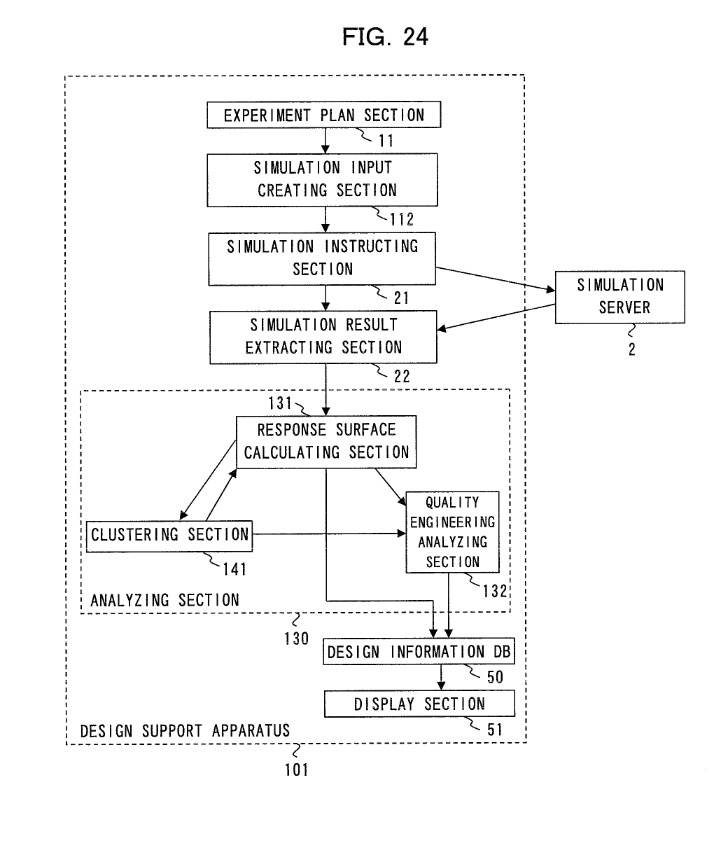

First, a configuration of the design support apparatus according to the second embodiment will be described. FIG. 24 is a block diagram showing an example of a configuration of the design support apparatus according to the second embodiment. In FIG. 24, the same reference numerals denote the same or corresponding parts as in FIG. 1, and the descriptions thereof will be omitted. FIG. 24 shows a design support apparatus 101 in place of the design support apparatus 1. The design support apparatus 101 includes a simulation input creating section 112 and analyzing section 130 in place of the simulation input creating section 12 and the analyzing section 30, respectively. The analyzing section 130 includes a response surface calculating section 131, quality engineering analyzing section 132 and clustering section 141 in place of the response surface calculating section 31, quality engineering analyzing section 32 and clustering section 41, respectively.

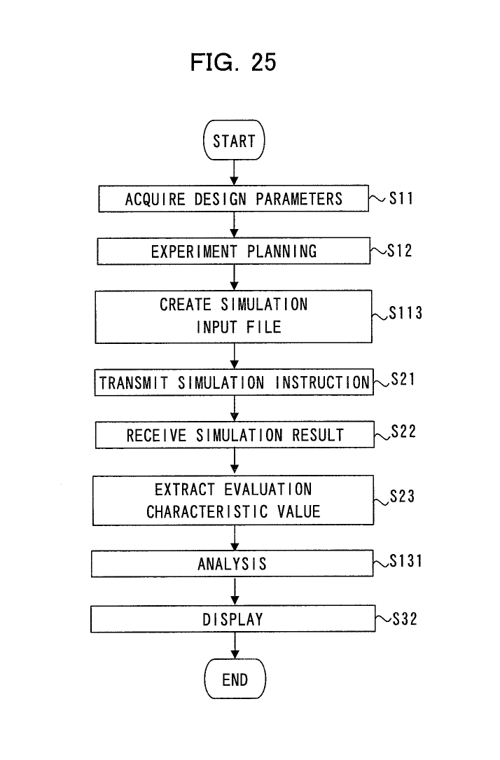

Next, operation of the design support apparatus according to the present embodiment will be described. FIG. 25 is a flowchart showing an example of operation of the design support apparatus according to the second embodiment. In FIG. 25, the same reference numerals denote the same or corresponding processing as in FIG. 2, and the descriptions thereof will be omitted. In FIG. 25, steps S113 and S131 are performed in place of steps S13 and S31, respectively.

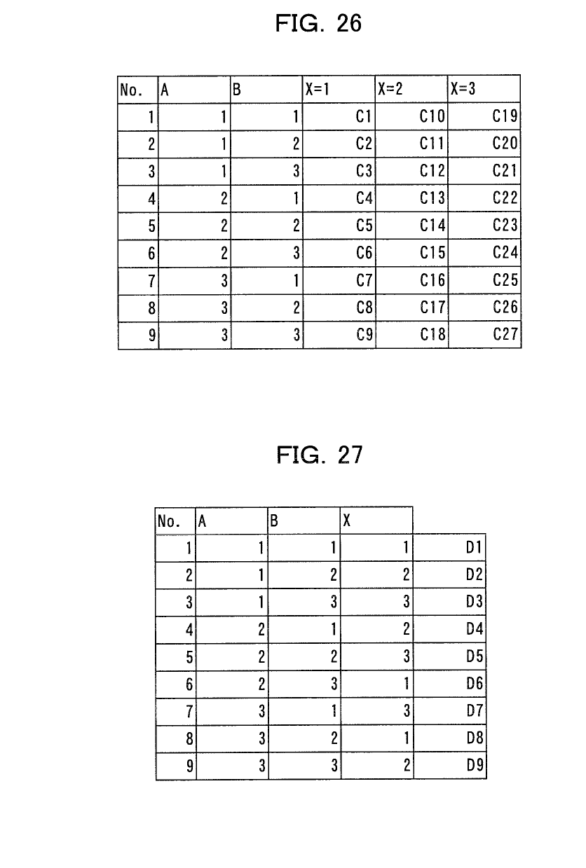

Here, the processing of step S113 will be described. FIG. 26 is an orthogonal table showing an example of allocation of the error factors in normal quality engineering. In this case, i.e., in the case where there are one three-level error factor (X) and two three-level control factors, 27 simulations (C1 to C27) needs to be performed in a normal quality engineering. The simulation input creating section 112 allocates the error factors and the like which are exterior factors in the normal quality engineering to an adequate orthogonal table as interior factors to thereby reduce the number of combinations of the design parameters used in the simulation. FIG. 27 is an orthogonal table showing an example of allocation of error factors made by the simulation input creating section according to the second embodiment. As shown in the examples of FIGS. 26 and 27, the simulation instructing section 61 can reduce the number of simulations from 27 (C1 to C27) to 9 (D1 to D9), thereby reducing the time required for the simulation by three times.

Then, the simulation input creating section 112 creates a simulation input file in a manner similar to the simulation input creating section 12.

Next, the processing of step S131 will be described. Sets of design parameters and evaluation characteristic value, the number of which has thus been reduced, are input from the simulation result extracting section 22 to analyzing section 130. The response surface calculating section 131 calculates a response surface from the sets the number of which has been reduced, allowing the analyzing section 130 to calculate an evaluation value relative to a given value of the control factor from the response surface. Therefore, although the number of the sets has been reduced by the simulation input creating section 112, it is possible to arbitrarily select the set used for analysis. Further, the analyzing section 130 uses an analysis method selected by a user to perform analysis. Here, five analysis methods will be described.

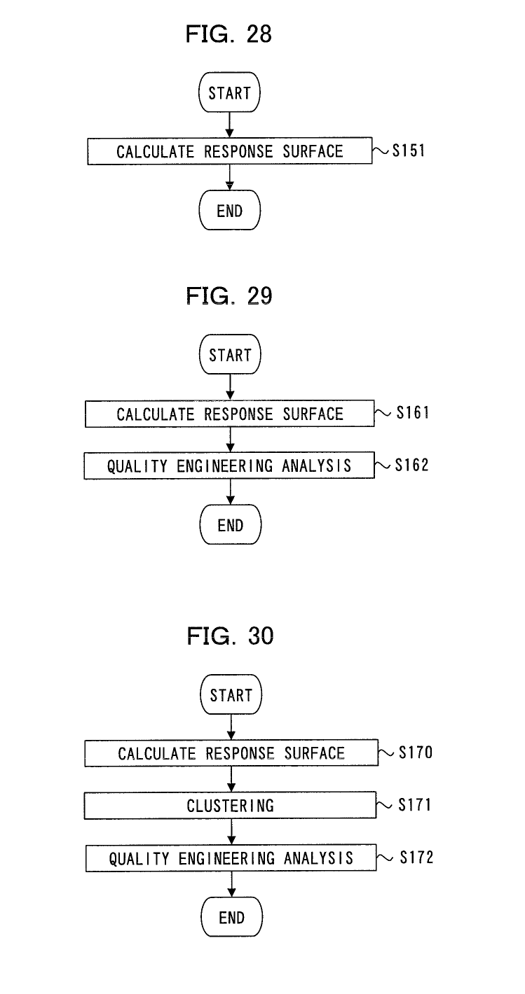

FIG. 28 is a flowchart showing an example of a first analysis method according to the second embodiment. In the first analysis method, the response surface calculating section 131 calculates a response surface in a manner similar to step S51 (S151) and ends this flow.

FIG. 29 is a flowchart showing an example of a second analysis method according to the second embodiment. In the second analysis method, the response surface calculating section 131 calculates a response surface in a manner similar to step S51 and outputs the calculated response surface to the quality engineering analyzing section 132 (S161). Then, the quality engineering analyzing section 132 uses the response surface obtained from the response surface calculating section 131 to calculate a given set of the control factor values and characteristic vale, calculate the degree of influence that the control factor exerts on the characteristic value, stores the calculated influence degree in the design information database as an analysis result (S162), and ends this flow.

FIG. 30 is a flowchart showing an example of a third analysis method according to the second embodiment. In the third analysis method, the response surface calculating section 131 performs the abovementioned calculation of a response surface and outputs the calculated response surface to the clustering section 141 (S170). Then, the clustering section 141 uses the response surface obtained from the response surface calculating section 131 to calculate a given set of the design parameter values and evaluation characteristic value and compares the evaluation characteristic value with a previously set design tolerance to thereby select a set of the design parameter values and evaluation characteristic value that can be designed. Further, the clustering section 141 performs clustering to classify the selected sets in a manner similar to step S71 and outputs, on a per cluster basis, the sets of the design parameter values and evaluation characteristic value to the quality engineering analyzing section 132 (S171). Then, the quality engineering analyzing section 132 calculates the degree of influence on a per cluster basis in a manner similar to step S41, stores the calculated influence degree in the design information database as an analysis result on a per cluster basis (S172), and ends this flow.

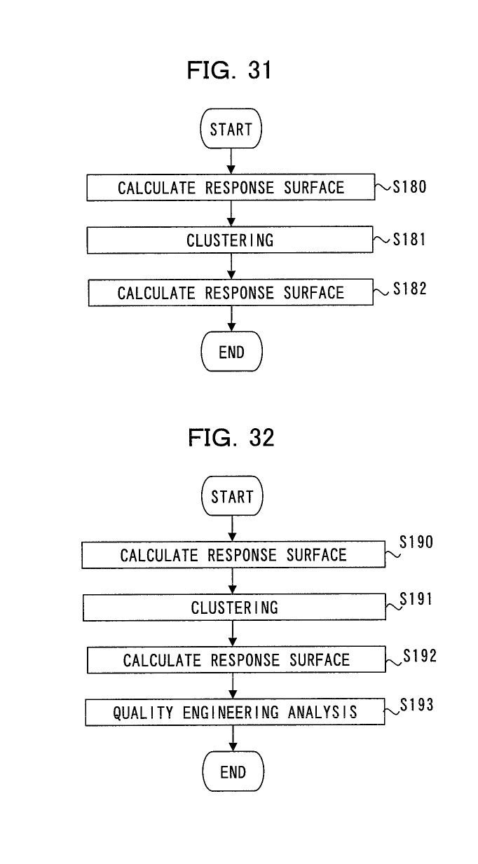

FIG. 31 is a flowchart showing an example of a fourth analysis method according to the second embodiment. The response surface calculating section 131 calculates a response surface in a manner similar to step S170 and outputs the calculated response surface to the clustering section 141 (S180). Then, the clustering section 141 performs clustering in a manner similar to step S171 and outputs the obtained sets of the design parameter values and evaluation characteristic value on a per cluster basis to the response surface calculating section 131 (S181). Then, the response surface calculating section 131 calculates, on a per cluster basis, a response surface in a manner similar to step S51, stores the calculated response surface in the design information database as an analysis result on a per cluster basis (S182), and ends this flow.

FIG. 32 is a flowchart showing an example of a fifth analysis method according to the second embodiment. The response surface calculating section 131 calculates a response surface in a manner similar to step S170 and outputs the calculated response surface to the clustering section 141 (S190). Then, the clustering section 141 performs clustering in a manner similar to step S171 and outputs, on a per cluster basis, the sets of the design parameter values and evaluation characteristic value to the response surface calculating section 131 (S191). Then, the response surface calculating section 131 calculates, on a per cluster basis, the abovementioned response surface and outputs the calculated response surface to the quality engineering analyzing section 132 (S192). Then, the quality engineering analyzing section 132 uses the response surface which has been obtained from the response surface calculating section 131 on a per cluster basis to calculate the degree of influence that a given value of the control factor, which is obtained based on the weighted center of the cluster, exerts on the characteristic value, stores the calculated influence degree in the design information database as an analysis result on a per cluster basis (S193), and ends this flow.

Further, it is possible to provide a program that allows a computer constituting the design support apparatus to execute the above steps as a design support program. By storing the above program in a computer-readable storage medium, it is possible to allow the computer constituting the design support apparatus to execute the program. The computer-readable medium mentioned here includes: an internal storage device mounted in a computer, such as ROM or RAM, a portable storage medium such as a CD-ROM, a flexible disk, a DVD disk, a magnet-optical disk, or an IC card; a database that holds computer program; another computer and database thereof; and a transmission medium on a network line.

An analyzing section corresponds to the response surface calculating section, quality engineering analyzing section, and clustering section in the embodiments.

### INDUSTRIAL APPLICABILITY

According to the present invention, it is possible to automatically complete experiment plan, simulation, and analysis, so that it is not necessary for a user to have advanced knowledge about the quality engineering. Further, by reducing the number of simulations and analyzing an arbitrary characteristic value using a response surface, it is possible to carry out analysis processing at very high speed. Further, by classifying the characteristic values into clusters and analyzing characteristics values for each cluster, highly accurate analysis can be achieved.

1. A design support apparatus that uses a simulation for obtaining a characteristic value of an object to be designed from a combination of design parameter values such as a control factor, error factor, and signal factor to analyze a relationship between the design parameter and characteristic value, comprising:
a experiment plan section that selects a combination of design parameter values by allocating the design parameter values to an orthogonal table;
a simulation input creating section that creates an input into the simulation by allocating outside factors such as an error factor and a signal factor as inside factors to an orthogonal table to thereby reduce the number of combinations of the design parameter values;
a simulation instructing section that issues an instruction to execute the simulation by using the input into the simulation; and
an analyzing section that calculates a set of design parameter values and a characteristic value based on results of the simulation and performs analysis.

2. The design support apparatus according to claim 1, further comprising:
a response surface calculating section that uses the design parameters and characteristic value obtained as a result of the simulation to calculate a response surface representing a relationship between the design parameter values and characteristic value, wherein
the analyzing section uses the response surface to calculate a given set of parameter values and characteristic value to perform analysis.

3. The design support apparatus according to claim 1, further comprising:
a clustering section that selects a set of design parameter values and characteristic value that satisfies a predetermined criterion and classifies the selected set thereof into clusters based on a distance between points represented by the selected sets thereof, wherein
the analyzing section uses the clustered sets of design parameters and characteristic value to perform analysis.

4. A design support apparatus that creates, as a simulation input file, a setting required for a simulation for obtaining a characteristic value of an object to be designed from a combination of design parameter values such as a control factor, error factor, and signal factor, comprising:
a experiment plan section that selects a combination of design parameter values by allocating the design parameter values to an orthogonal table; and
a simulation input creating section that previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

5. The design support apparatus according to claim 1, wherein
the simulation input creation section allocates outside factors such as an error factor and a signal factor as inside factors to an orthogonal table to thereby reduce the number of combinations of the design parameter values, previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

6. A design support method that uses a simulation for obtaining a characteristic value of an object to be designed from a combination of design parameter values such as a control factor, error factor, and signal factor to analyze a relationship between the design parameter and characteristic value, comprising:
a experiment plan step that selects a combination of design parameter values by allocating the design parameter values to an orthogonal table;
a simulation input creating step that creates an input into the simulation by allocating outside factors such as an error factor and a signal factor as inside factors to an orthogonal table to thereby reduce the number of combinations of the design parameter values;
a simulation instructing step that issues an instruction to execute the simulation by using the input into the simulation; and
an analyzing step that calculates a set of design parameter values and a characteristic value based on results of the simulation and performs analysis.

7. The design support method according to claim 6, further comprising between the simulation instructing step and analyzing step:
a response surface calculating step that uses the design parameters and characteristic value obtained as a result of the simulation to calculate a response surface representing a relationship between the design parameter values and characteristic value, wherein
the analyzing step uses the response surface to calculate a given set of parameter values and characteristic value to perform analysis.

8. The design support method according to claim 6 further comprising between the simulation instructing step and analyzing step:
a clustering step that selects a set of design parameter values and characteristic value that satisfies a predetermined criterion and classifies the selected set thereof into clusters based on a distance between points represented by the selected sets thereof, wherein
the analyzing step uses the clustered sets of design parameters and characteristic value to perform analysis.

9. A design support method that creates, as a simulation input file, a setting required for a simulation for obtaining a characteristic value of an object to be designed from a combination of design parameter values such as a control factor, error factor, and signal factor, comprising:
a experiment plan step that selects a combination of design parameter values by allocating the design parameter values to an orthogonal table; and
a simulation input creating step that previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

10. The design support method according to claim 6, wherein
the simulation input creation step allocates outside factors such as an error factor and a signal factor as inside factors to an orthogonal table to thereby reduce the number of combinations of the design parameter values, previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

11. A design support program allowing a computer to execute a design support method that uses a simulation for obtaining a characteristic value of an object to be designed from a combination of design parameter values such as a control factor, error factor, and signal factor to analyze a relationship between the design parameter and characteristic value, the program allowing the computer to execute:
a experiment plan step that selects a combination of design parameter values by allocating the design parameter values to an orthogonal table;
a simulation input creating step that creates an input into the simulation by allocating outside factors such as an error factor and a signal factor as inside factors to an orthogonal table to thereby reduce the number of combinations of the design parameter values;
a simulation instructing step that issues an instruction to execute the simulation by using the input into the simulation; and
an analyzing step that calculates a set of design parameter values and a characteristic value based on results of the simulation and performs analysis.

12. The design support program according to claim 11 further comprising between the simulation instructing step and analyzing step:
a response surface calculating step that uses the design parameters and characteristic value obtained as a result of the simulation to calculate a response surface representing a relationship between the design parameter values and characteristic value, wherein
the analyzing step uses the response surface to calculate a given set of parameter values and characteristic value to perform analysis.

13. The design support program according to claim 11 further comprising between the simulation instructing step and analyzing step:
a clustering step that selects a set of design parameter values and characteristic value that satisfies a predetermined criterion and classifies the selected set thereof into clusters based on a distance between points represented by the selected sets thereof, wherein
the analyzing step uses the clustered sets of design parameters and characteristic value to perform analysis.

14. A design support program allowing a computer to execute a design support method that creates, as a simulation input file, a setting required for a simulation for obtaining a characteristic value of an object to be designed from a combination of design parameter values such as a control factor, error factor, and signal factor, the program allowing the computer to execute:
a experiment plan step that selects a combination of design parameter values by allocating the design parameter values to an orthogonal table; and
a simulation input creating step that previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.

15. The design support program according to claim 11, wherein
the simulation input creation step allocates outside factors such as an error factor and a signal factor as inside factors to an orthogonal table to thereby reduce the number of combinations of the design parameter values, previously prepares a correspondence between design parameter names and identifiers, previously prepares a simulation input template file which is a file describing the design parameter values in the simulation input file using corresponding identifiers, outputs for each combination of the design parameter values the simulation input file in which the identifiers in the simulation input template file have been replaced with design parameter values according to the correspondence, and in the case where the name of an error factor included in the design parameters coincides with the name of a control factor, replaces the identifier corresponding to the error factor name with a value obtained by adding the value of the error factor to value of the control factor.
